(19) United States
(12) Patent Application Publication
(10) Pub. No.: US 2019/0216099 A1
(43) Pub. Date: Jul. 18, 2019

(54) Cutter for cutting elongate foodstuffs

(71) Applicant: Polar device oy, Oulu (FI)

(72) Inventors: Haili LI, Oulu (FI); Lina LI, Kerava (FI); Yafu LI, Kerava (FI); Chengqian DENG, Kerava (FI)

(73) Assignee: Polar device oy, Oulu (FI)

(21) Appl. No.: 16/330,778

(22) PCT Filed: Aug. 9, 2017
(86) PCT No.: PCT/FI2017/050566

§ 371 Date: Mar. 6, 2019

(30) Foreign Application Priority Data
Sep. 20, 2016 (FI) 20165705

(51) Int. Cl. A21C 11/24

(52) U.S. Cl. CPC A21C 11/24

(57) ABSTRACT

A cutter for cutting elongated foodstuff includes a frame, via which frame, the cutter is connected to a support surface or surfaces, and two cutting rollers connected to the frame in parallel in relation to each other at a distance apart. The cutting rollers include a plurality of circular cutting blades, and the cutter includes means for adjusting the distance between the cutting rollers by rotating the cutter or part of the cutter in relation to its support surface or surfaces. The means for adjusting the distance between cutting rollers includes a two-part frame, where the first roller is connected to the first frame part, and the second roller is connected to the second frame part. Further disclosed is an apparatus for producing elongated foodstuff equipped with such a cutter.

The present invention relates to producing elongate foodstuff, such as noodles and different types of elongate pastas. More precisely the invention relates to a cutter for cutting the pre-produced and compressed dough to strips, and to an apparatus for producing elongate foodstuff equipped with such a cutter.

The prior art noodle and pasta machines sold to households and used commercially operate according to two different main principles. The first operating principle is extrusion, which tends to produce dense structured end products, which corresponds more to spaghetti than proper noodles. The second operating principle is elongation by compression, which produces end products more properly corresponding to proper noodles.

The prior art machines for commercial production of noodles comprises one or more pairs of rollers for compressing the dough material and the sheet formed from the dough material.

Publication WO 2016/005653 A1 discloses one solution for producing elongated foodstuffs, such as pasta and noodles, where the dough is first mixed and then compressed between a pair of rollers several times.

After the dough has obtained suitable compression and elongation, the dough is cut to strips to form noodles or strip pasta. This cutting is generally done via a plurality of rotating cutting blades forming a two cutting rollers setting against each other, between which cutting rollers the elongated and compressed dough material is conveyed.

In the prior art solutions the cutting rollers form an integral or detachable part of the producing machine, which is arduous to remove from and add to the producing machine when the end product is changed from noodles to pasta plates, and vice versa, for example.

The present invention provides a novel cutting solution, which can be easily adjustable to the different pasta and noodle widths, and which can be easily moved in and out of use.

The present invention provides a cutter for cutting elongate foodstuff, which cutter comprises a frame, via which frame the cutter is connected to a support surface or surfaces, and two cutting rollers connected to the frame in parallel in relation to each other at a distance apart, which cutting rollers comprises a plurality of circular cutting blades, and the cutter comprises means for adjusting the said distance between the cutting rollers by rotating the cutter or part of the cutter in relation to its support surface or surfaces.

In the cutter of the invention the means for adjusting the distance between cutting rollers comprises a two-part frame, where the first roller is connected to the first frame part, and the second roller is connected to the second frame part, and the second frame part is connected to the first frame part via fixing points forming turning axis, which turning axis is parallel but non-concentric with the rotating axis of the first roller. In this embodiment the first frame part can also be formed by the said support surface or surfaces.

In an embodiment of the cutter of the invention the first and last circular cutting blade of both cutting rollers have diameter greater than other cutting blades of the cutting rollers. This allows guidance of the proper alignment of the middle cutting blades in the cutting rollers during the cutting process.

In an embodiment of the cutter of the invention the circular cutting blades between the first and last cutting blade in each roller comprises cutting blades of two different diameters arranged so that between each set of bigger diameter cutting blades is a smaller diameter cutting blade. Also each cutting blade in each of the cutting rollers is arranged a distance a part from the next, which distance substantially corresponds to the thickness of the cutting blade.

The present invention also provides an apparatus for producing elongate foodstuff, which comprises an above described cutter.

The features defining a cutter of the invention are more precisely presented in claim 1, and features defining an apparatus of the invention are more precisely presented in claim 5. Dependent claims present advantageous features and embodiments of the invention.

An exemplifying embodiment and its advantages are explained in greater detail below in the sense of an example and with reference to the accompanying figures, where

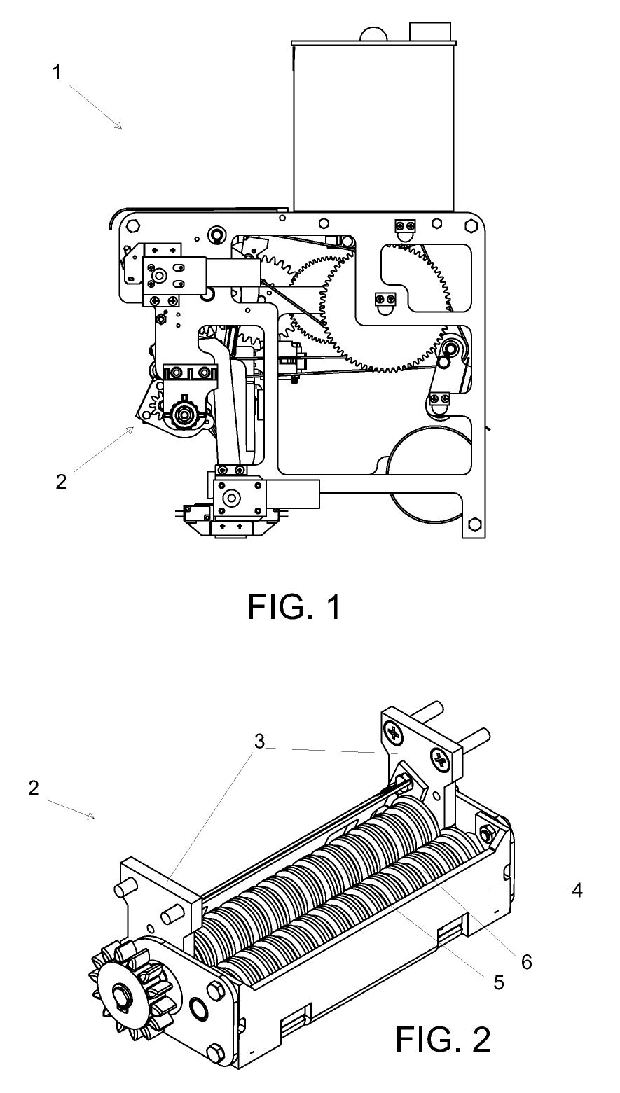

FIG. 1 shows schematically an apparatus with a cutter in accordance with the present invention,

FIG. 2 shows schematically the cutter of FIG. 1,

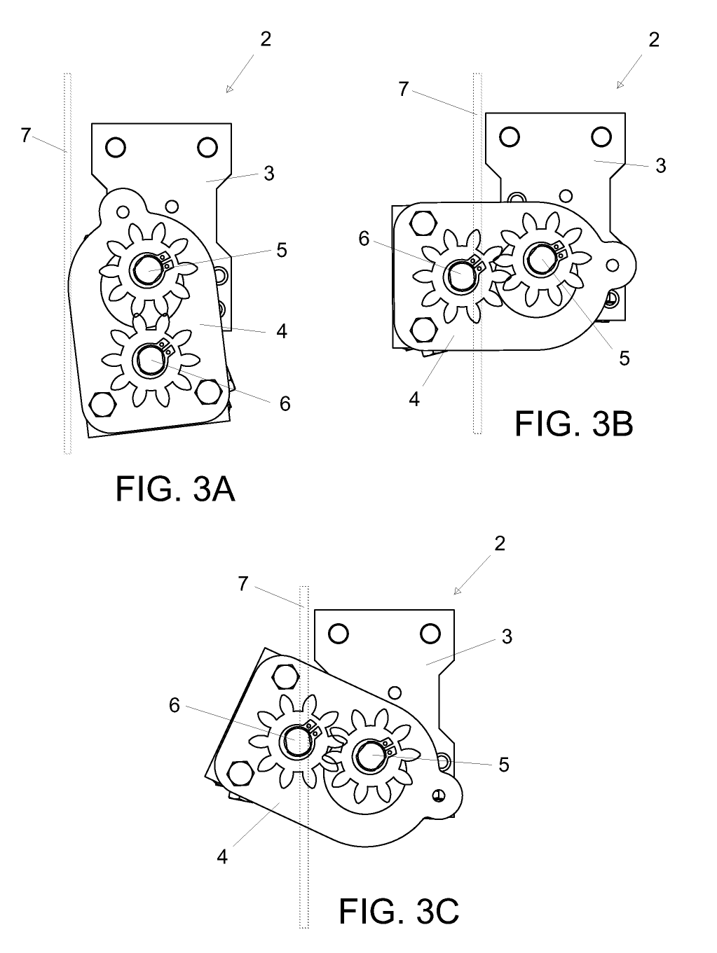

FIGS. 3A-3C shows schematically the main positions of the cutter of FIGS. 1 and 2, and

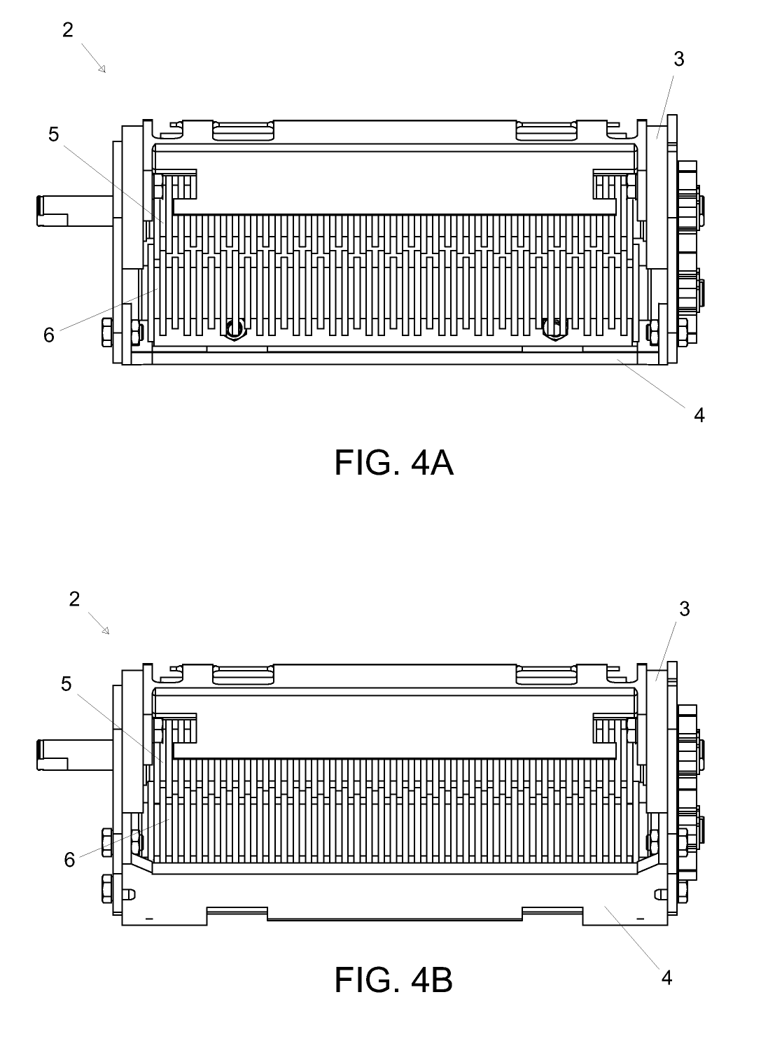

FIGS. 4A and 4B shows schematically the cutter of previous figures at main cutting positions as a top view.

FIG. 1 shows schematically an apparatus 1 with a cutter 2 in accordance with the present invention. The apparatus 1 is in this embodiment a noodle and pasta making machine, like one disclosed in publication WO 2016/005653 A1.

Once the pasta or noodle dough has been prepared by the apparatus 1, one of the last stages of the preparation process is to lead the produced dough belt to the cutter 2, which cuts the dough belt to noodle or pasta strips of desired width. Alternatively, the cutter 2 can be turned away from the path of the dough belt, so that dough sheets, such as pasta plates or sheets, may be produced.

FIG. 2 shows schematically the cutter 2 of FIG. 1 in more detail. The cutter 2 comprises two frame parts 3 and 4, and two cutting rollers 5 and 6. The cutting rollers 5 and 6 comprise a plurality of circular cutting blades for cutting the dough sheet passing between the cutting rollers to strips.

The cutter 2 is connected to a suitable support surface or surfaces of the apparatus 1 via the first frame part 3. To the first frame part 3 is also connected rotatably the first cutting roller 5. The first frame part 1 can alternatively be integrally formed to and by the support surface or surfaces.

To the first frame part 3 is connected turnably the second frame part 4. To the second frame part 4 also connected rotatably the second cutting roller 6. The fixing points of the second frame part 4 define a turning axis for the second frame part, which turning axis is substantially parallel with the rotating axis of the first cutting roller 5, but the rotating axis of the first cutting roller 5 and the turning axis of the second frame part 4 are not aligned. This obtains eccentric movement for the second cutting roller 6 in relation to the first cutting roller 5, and thus also the change of distance between the substantially parallel first and second cutting roller, when the second frame part 4 is turned in relation to the first frame part 3.

FIGS. 3A-3B show schematically the main positions of the cutter 2 of FIGS. 1 and 2. In the FIGS. 3A-3C the orientation of the first frame part 3 corresponds to the orientation in which it is connected to the apparatus 1 of FIG. 1.

In the position shown in FIG. 3A, the cutter 2 is in non-operational position, i.e. the pasta or noodle sheet 7 passes the cutting rollers 5 and 6 and no cutting to strips is performed. In this position the second frame part 4 of the cutter 2 is turned directly below the first frame part 3.

In the position shown in FIG. 3B, the second frame part 4 of the cutter 2 is turned little below horizontal plane, i.e. the plane substantially perpendicular to the vertical plane defined by the position of the first frame part 3, and the apparatus 1 in its operating position. In this position the pasta or noodle sheet is conveyed between the cutting rollers 5 and 6, and the sheet is cut in strips. In this position the cutting rollers 5 and 6 are farthest apart, i.e. the cut strips are of maximum width.

In the position shown in FIG. 3C, the outer end of the second frame part 4 of the cutter 2 is turned further upwards from the position of FIG. 3B, and with this turning movement the second cutting roller 6 is moved closer to the fist cutting roller 5, in the position where these two rollers are closest to each other. In this position the cut strips are at minimum width.

In the FIGS. 4A and 4B is shown schematically the cutter 2 as a top views at different operation positions. FIG. 4A corresponds to the position shown in FIG. 3B, where the cut strips are of maximum width, and FIG. 4B corresponds to the position shown in FIG. 3C, where the cut strips are of minimum width.

As can be seen from these figures, both of the cutting rollers 5 and 6 comprises a plurality of circular cutting blades, where the first cutting blades on both ends of the both rollers have greater diameter that the rest of the cutting blades. These circular edge cutting blades guide the other cutting blades between them to a proper orientation in relation to each other and in relation to the cutting blades in the other cutting roller. Further, the circular cutting blades between the edge cutting blades have two different diameters and are arranged so that between each set of two bigger diameter cutting blades is located a smaller diameter cutting blade at a distance from the bigger diameter cutting blades. Also each cutting blade in each of the cutting rollers 5 and 6 is arranged a distance a part from the next, which distance substantially corresponds to the thickness of the cutting blade.

In the position shown in FIG. 4A, the dough belt conveyed between the cutting rollers 5 and 6 is cut to strips having maximum width. In this cutting position the dough belt is cut only with the cutting blades having bigger diameter, so the width of the cut strip corresponds to the distance between the side surfaces of the bigger diameter cutting blades.

In the position shown in FIG. 4B, the dough belt conveyed between the cutting roller 5 and 6 is cut to strips having minimum width. in this cutting position the dough belt is cut with all of the cutting blades, i.e. both with the smaller and bigger diameter cutting blades, so the width of the cut strip corresponds to the distance between side surfaces of two consecutive cutting blades.

The specific exemplifying embodiment of the invention shown in figures and discussed above should not be construed as limiting. A person skilled in the art can amend and modify the embodiment in many evident ways within the scope of the attached claims. Thus the invention is not limited merely to the embodiment described above.

1. A cutter for cutting elongated foodstuff, comprising a frame, via which frame, the cutter is connected to a support surface or surfaces, and two cutting rollers connected to the frame in parallel in relation to each other at a distance apart, which cutting rollers, comprising a plurality of circular cutting blades, and the cutter comprising means for adjusting a distance between the cutting rollers by rotating the cutter or part of the cutter in relation to its support surface or surfaces, wherein the means for adjusting the distance between cutting rollers comprises a two-part frame, where the first roller is connected to the first frame part, and the second roller is connected to the second frame part, and the second frame part is connected to the first frame part via fixing points forming a turning axis, which turning axis is parallel but non-concentric with the rotating axis of the first roller.

2. The cutter according to claim 1, wherein a first and a last circular cutting blade of both cutting rollers have diameter greater than other cutting blades of the cutting rollers.

3. The cutter according to claim 1, wherein the circular cutting blades between the first and last cutting blade in each roller comprise cutting blades of two different diameters arranged, so that, between each set of two bigger diameter cutting blades, is a smaller diameter cutting blade.

4. The cutter according to claim 1, wherein the cutter is a part of an apparatus for producing elongate elongated foodstuff.

5. An apparatus producing elongated foodstuff, comprising a cutter according to claim 1.
